(19) United States
(12) Patent Application Publication
(10) Pub. No.: US 2020/0390084 A1
(43) Pub. Date: Dec. 17, 2020

(54) Hunting Game Transport Assembly

(71) Applicant: James Edwards, Munhall, PA (US)

(72) Inventor: James Edwards, Munhall, PA (US)

(21) Appl. No.: 16/437,955

(22) Filed: Jun. 11, 2019

(51) Int. Cl. A01M 31/00; B62B 1/20; B62B 1/22

(52) U.S. Cl. CPC A01M 31/006; B62B 2202/42; B62B 1/22; B62B 1/208

(57) ABSTRACT

A hunting game transport assembly for transporting hunting game out of a hunting area includes a frame that is positionable in a collapsed position to be carried into a hunting area. The frame is positionable in a deployed position when the frame is carried into the hunting area. A wheel is rotatably coupled to the frame to roll along a support surface when the frame is positioned in the deployed position. A net is coupled to the frame and hunting game is positionable on the net when the frame is positioned in the deployed position. The frame is gripped having the wheel abutting the support surface to transport the hunting game along the support surface.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to transport devices and more particularly pertains to a new transport device for transporting hunting game out of a hunting area.

### BRIEF SUMMARY OF THE INVENTION

An embodiment of the disclosure meets the needs presented above by generally comprising a frame that is positionable in a collapsed position to be carried into a hunting area. The frame is positionable in a deployed position when the frame is carried into the hunting area. A wheel is rotatably coupled to the frame to roll along a support surface when the frame is positioned in the deployed position. A net is coupled to the frame and hunting game is positionable on the net when the frame is positioned in the deployed position. The frame is gripped having the wheel abutting the support surface to transport the hunting game along the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a hunting game transport assembly according to an embodiment of the disclosure.

FIG. 2 is a top view of an embodiment of the disclosure.

FIG. 3 is a right side view of an embodiment of the disclosure.

FIG. 4 is a bottom view of an embodiment of the disclosure.

FIG. 5 is a bottom view of an embodiment of the disclosure showing a frame being positioned into a folded position.

FIG. 6 is a perspective in-use view of an embodiment of the disclosure.

### DETAILED DESCRIPTION OF THE INVENTION

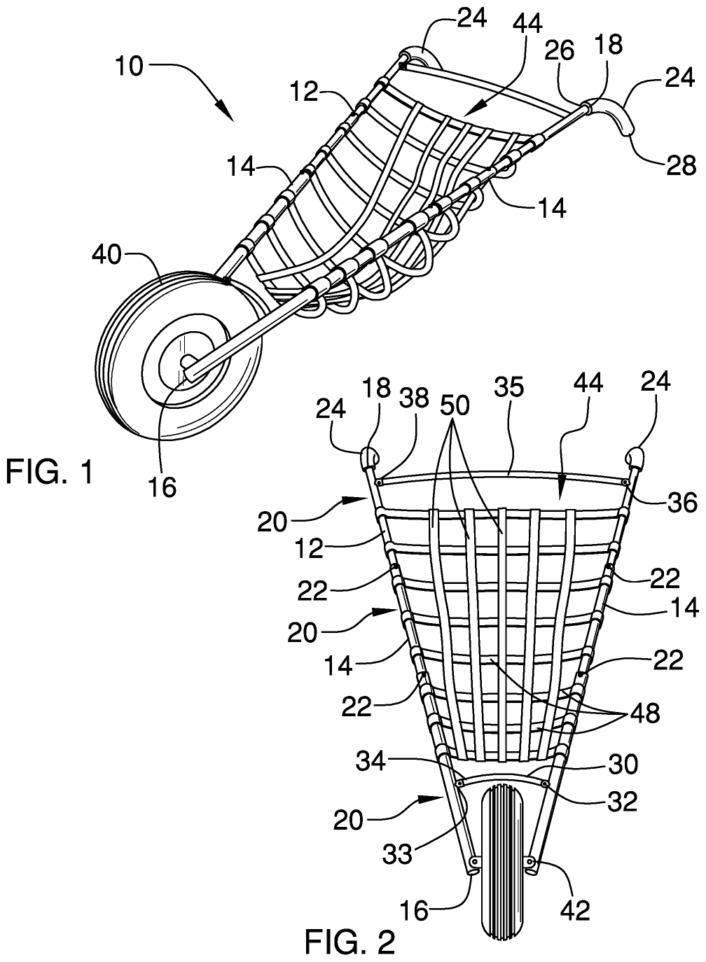

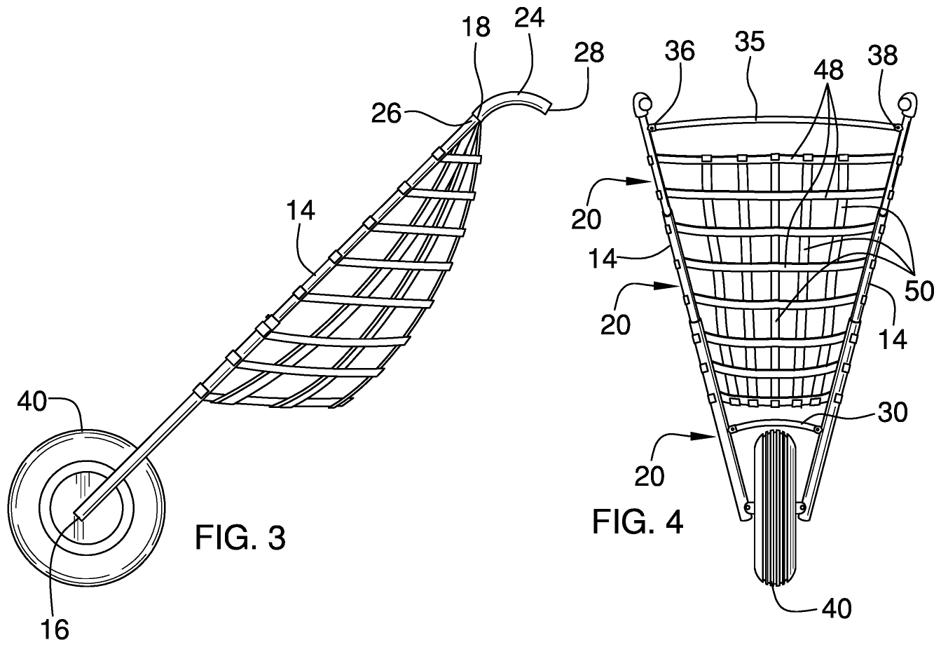

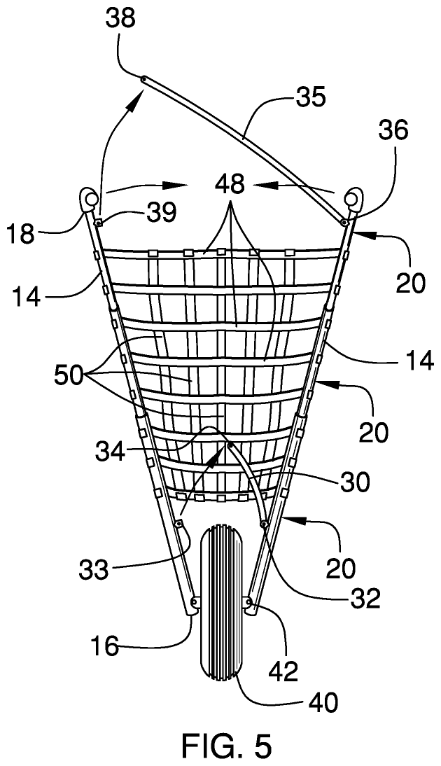

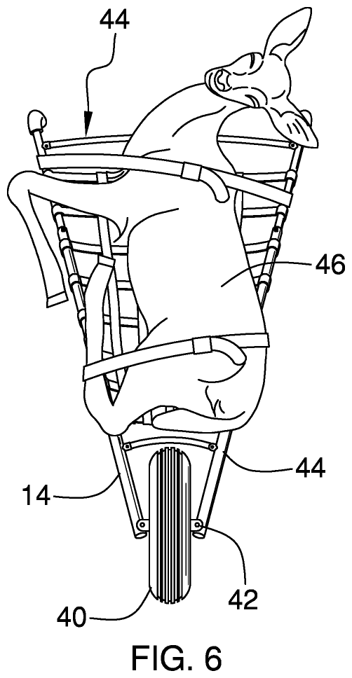

With reference now to the drawings, and in particular to FIGS. 1 through 6 thereof, a new transport device embodying the principles and concepts of an embodiment of the disclosure and generally designated by the reference numeral 10 will be described.

As best illustrated in FIGS. 1 through 6, the hunting game transport assembly 10 generally comprises a frame 12 that is positionable in a collapsed position such that the frame 12 can be carried into a hunting area. The frame 12 can be carried on a hunter's back, packed into a hunting bag or carried in any other manner. The frame 12 is positionable in a deployed position when the frame 12 is carried into the hunting area. The frame 12 comprises a pair of tubes 14 that each has a first end 16 and a second end 18. Each of the tubes 14 comprises a plurality of sections 20 that slidably engage each other such that each of the tubes 14 has a telescopically adjustable length.

The tubes 14 are positioned adjacent to each other and are coextensive with each other when the frame 12 is positioned in the collapsed position. The tubes 14 are aligned with each other and angle away from each other between the first 16 and second 18 ends when the frame 12 is positioned the deployed position. Moreover, the tubes 14 form a V shape when the frame 12 is positioned in the deployed position. A plurality of locks 22 is each movably coupled to a respective one of the sections 20 of a respective one of the tubes 14. Each of the locks 22 releasably engages an adjacent one of the sections 20 on the respective tube 14 for retaining the respective tube 14 at a selected telescopic length. Each of the locks 22 may comprise a ball that is biased outwardly from the respective tube 14 or other similar, releasable lock that is common to telescopic members.

A pair of handles 24 is provided and each of the handles 24 has a primary end 26 and a secondary end 28. The primary end 26 of each of the handles 24 is coupled to the second end 18 of a respective one of the tubes 14. Each of the handles 24 can be gripped when the frame 12 is positioned in the deployed position. Moreover, each of the handles 24 is curved between the primary 26 and secondary 28 ends such that the secondary end 28 of each of the handles 24 is directed downwardly from the respective tube 14.

The frame 12 includes a first support 30 that has a first end 32 and second end 34. The first end 32 of the first support 30 is pivotally coupled to a respective one of the tubes 14. The first support 30 is oriented perpendicular to the respective tube 14 and releasably engages the other one of the tubes 14 when the frame 12 is positioned in the deployed position. Additionally, the first support 30 is positioned closer to the first end 16 of the respective tube 14 than the second end 18 of the respective tube 14. The first support 30 may engage a coupler 33 or other similar structure that is positioned on the other tube 14 with respect to the first support 30.

The frame 12 includes a second support 35 that has a first end 36 and a second end 38. The first end 36 of the second support 35 is pivotally coupled to the tube 14 on which the first support 30 is pivotally coupled. The second support 35 releasably engages the other one of the tubes 14 when the frame 12 is positioned in the deployed position. Moreover, the second support 35 is positioned closer to the second end 18 of the respective tube 14 than the first end 16 of the respective tube 14. The second support 35 has a length that is greater than a length of the first support 30. Thus, the first 30 and second 34 supports retain the tubes 14 in the V-shape when the first 30 and second 34 supports are positioned to extend between the tubes 14. The second support 35 may engage a coupler 39 or other similar structure that is positioned on the other tube with respect to the second support 35.

A wheel 40 is rotatably coupled to the frame 12 to roll along a support surface 41, such as ground or the like, when the frame 12 is positioned in the deployed position. The wheel 40 includes an axle 42 and each end of the axle 42 has a respective one of the tubes 14 of the frame 12 being pivotally coupled thereto. In this way the wheel 40 has a rotational axis that is oriented perpendicular to a line extending through the first 16 and second 18 ends of the tubes 14. The axle 42 is positioned adjacent to the first end 16 of each of the tubes 14 and the wheel 40 may include an inflatable rubber tire or other similar tire that rolls on the support surface 41.

A net 44 is coupled to the frame 12 and hunting game 46 is positioned on the net 44 when the frame 12 is positioned in the deployed position. The frame 12 is gripped having the wheel 40 abutting the support surface 41 thereby facilitating the hunting game 46 to be rolled along the support surface 41. In this way the hunting game 46 can be transported without requiring the hunter to carry, drag or otherwise manually transport the hunting game 46. Additionally, the net 44 has a length and a width sufficient to accommodate a white tail deer or other similar, medium sized hunting game 46.

The net 44 comprises a plurality of horizontal straps 48 that is each coupled between each of the tubes 14. The horizontal straps 48 are spaced apart from each other and are distributed between the first 30 and second 34 supports. A plurality of vertical straps 50 is each coupled to and extends between each of the horizontal straps 48. The vertical straps 50 are spaced apart from each other and are distributed between the tubes 14.

In use, the frame 12 is positioned in the folded position for carrying the frame 12, wheel 40 and net 44 into the hunting area. The frame 12 can be positioned in the deployed position when hunting game 46, such as a deer or the like, has been successfully hunted. Each of the handles 24 is gripped for rolling the wheel 40 along the support surface 41 to transport the frame 12 to the hunted game 46. The hunted game 46 is laid onto the net 44 and straps or ropes can be used to tie the hunted game 46 onto the net 44. Each of the handles 24 is gripped and the wheel 40 is rolled along the support surface 41 to transport the hunted game 46 to a desired location. In this way the hunted game 46 can be transported without requiring the hunter to drag or carry the hunted game 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hunting game transport assembly being configured to transport hunted game out of a hunting area, said assembly comprising:
a frame being positionable in a collapsed position wherein said frame is configured to be carried into a hunting area, said frame being positionable in a deployed position when said frame is carried into the hunting area said frame comprising a pair of tubes, each of said tubes having a first end and a second end, each of said tubes comprising a plurality of sections being slidably engaging each other such that each of said tubes has a telescopically adjustable length, said tubes being positioned adjacent to each other and being coextensive with each other when said frame is positioned in said collapsed position, said tubes being aligned with each other and angling away from each other between said first and second ends when said frame is positioned said deployed position having said tubes forming a V shape;
a wheel being rotatably coupled to said frame wherein said wheel is configured to roll along a support surface when said frame is positioned in said deployed position; and
a net being coupled to said frame wherein said net is configured to have hunting game being positioned thereon when said frame is positioned in said deployed position, said frame being gripped having said wheel abutting the support surface wherein said frame is configured to transport the hunting game along the support surface.

2. (canceled)

3. The assembly according to claim 1, further comprising a plurality of locks, each of said locks being movably coupled to a respective one of said sections of a respective one of said tubes, each of said locks releasably engaging an adjacent one of said sections on said respective tube for retaining said respective tube at a selected telescopic length.

4. The assembly according to claim 3, further comprising a pair of handles, each of said handles having a primary end and a secondary end, said primary end of each of said handles being coupled to said second end of a respective one of said tubes wherein each of said handles is configured to be gripped when said frame is positioned in said deployed position, each of said handles being curved between said primary and secondary ends such that said secondary end of each of said handles is directed downwardly from said respective tube.

5. The assembly according to claim 1, further comprising a first support having a first end and second end, said first end of said first support being pivotally coupled to a respective one of said tubes, said first support being oriented perpendicular to said respective tube and releasably engaging the other one of said tubes when said frame is positioned in said deployed position, said first support being positioned closer to said first end of said respective tube than said second end of said respective tube.

6. The assembly according to claim 5, further comprising a second support having a first end and a second end, said first end of said second support being pivotally coupled to said tube on which said first support is pivotally coupled, said second support releasably engaging said other one of said tubes when said frame is positioned in said deployed position, said second support being positioned closer to said second end of said respective tube than said first end of said respective tube, said second support having a length being greater than a length of said first support such that said first and second supports retains said tubes in said V-shape when said first and second supports are positioned to extend between said tubes.

7. The assembly according to claim 1, wherein said wheel includes an axle, each end of said axle having a respective one of said tubes of said frame being pivotally coupled thereto such that said wheel has a rotational axis being oriented perpendicular to a line extending through said first and second ends of said tubes, said axle being positioned adjacent to said first end of each of said tubes.

8. The assembly according to claim 6, wherein said net comprises a plurality of horizontal straps, each of said horizontal straps being coupled between each of said tubes, said horizontal straps being spaced apart from each other and being distributed between said first and second supports.

9. The assembly according to claim 8, wherein said net comprises a plurality of vertical straps, each of said vertical straps being coupled to and extending between each of said horizontal straps, said vertical straps being spaced apart from each other and being distributed between said tubes.

10. A hunting game transport assembly being configured to transport hunted game out of a hunting area, said assembly comprising:
a frame being positionable in a collapsed position wherein said frame is configured to be carried into a hunting area, said frame being positionable in a deployed position when said frame is carried into the hunting area, said frame comprising:
a pair of tubes, each of said tubes having a first end and a second end, each of said tubes comprising a plurality of sections being slidably engaging each other such that each of said tubes has a telescopically adjustable length, said tubes being positioned adjacent to each other and being coextensive with each other when said frame is positioned in said collapsed position, said tubes being aligned with each other and angling away from each other between said first and second ends when said frame is positioned said deployed position having said tubes forming a V shape;
a plurality of locks, each of said locks being movably coupled to a respective one of said sections of a respective one of said tubes, each of said locks releasably engaging an adjacent one of said sections on said respective tube for retaining said respective tube at a selected telescopic length;
a pair of handles, each of said handles having a primary end and a secondary end, said primary end of each of said handles being coupled to said second end of a respective one of said tubes wherein each of said handles is configured to be gripped when said frame is positioned in said deployed position, each of said handles being curved between said primary and secondary ends such that said secondary end of each of said handles is directed downwardly from said respective tube;
a first support having a first end and second end, said first end of said first support being pivotally coupled to a respective one of said tubes, said first support being oriented perpendicular to said respective tube and releasably engaging the other one of said tubes when said frame is positioned in said deployed position, said first support being positioned closer to said first end of said respective tube than said second end of said respective tube; and
a second support having a first end and a second end, said first end of said second support being pivotally coupled to said tube on which said first support is pivotally coupled, said second support releasably engaging said other one of said tubes when said frame is positioned in said deployed position, said second support being positioned closer to said second end of said respective tube than said first end of said respective tube, said second support having a length being greater than a length of said first support such that said first and second supports retains said tubes in said V-shape when said first and second supports are positioned to extend between said tubes;
a wheel being rotatably coupled to said frame wherein said wheel is configured to roll along a support surface when said frame is positioned in said deployed position, said wheel including an axle, each end of said axle having a respective one of said tubes of said frame being pivotally coupled thereto such that said wheel has a rotational axis being oriented perpendicular to a line extending through said first and second ends of said tubes, said axle being positioned adjacent to said first end of each of said tubes; and
a net being coupled to said frame wherein said net is configured to have hunting game being positioned thereon when said frame is positioned in said deployed position, said frame being gripped having said wheel abutting the support surface wherein said frame is configured to transport the hunting game along the support surface, said net comprising:
a plurality of horizontal straps, each of said horizontal straps being coupled between each of said tubes, said horizontal straps being spaced apart from each other and being distributed between said first and second supports; and
a plurality of vertical straps, each of said vertical straps being coupled to and extending between each of said horizontal straps, said vertical straps being spaced apart from each other and being distributed between said tubes.
